(19) United States
(12) Patent Application Publication
(10) Pub. No.: US 2004/0149319 A1
(43) Pub. Date: Aug. 5, 2004

(54) Method of decontamination or preventing contamination of surfaces by an exchange mechanism

(76) Inventors: Franck Rouppert, St Pierre De Bressieux (FR); Annie Rivoallan, Villebon (FR); Christophe Largeron, Meylan (FR)

Correspondence Address: Burns Doane, Swecker & Mathis, Suite 400, 1737 King Street, Alexandria, VA, 22314-2727, US

(21) Appl. No.: 10/478,763

(22) PCT Filed: May 28, 2002
(86) PCT No.: PCT/FR02/01781

(30) Foreign Application Priority Data
May 29, 2001 (FR) 01/06985

(51) Int. Cl. B08B 3/00

(52) U.S. Cl. 134/29; 134/2; 134/26

(57) ABSTRACT

The invention relates to a method of decontamination or preventing contamination of surfaces by an exchange mechanism.

The method for decontamination of a surface contaminated by contaminants Z₁, is characterised in that the surface is brought into contact with an aqueous solution containing chemical species Z₂ that can displace contaminants Z₁ by an exchange mechanism at fixation sites on the surface of contaminants Z₁ such that the contaminants Z₁ are replaced by chemical species Z₂ on these fixation sites, and the aqueous solution containing the contaminants Z₁ thus displaced is separated from the decontaminated surface.

This method is applicable to decontamination of stainless steel surfaces contaminated by caesium by means of chemical species Z₂ consisting of Na⁺ ions.

### TECHNICAL FIELD

The purpose of this invention is a method for decontamination of contaminated surfaces, particularly metallic surfaces.

It is applicable to decontamination, maintenance and dismantling of installations for the nuclear industry.

### PRIOR ART

Various mechanisms are used in surface decontamination methods, particularly in the nuclear industry.

Thus, there are many known methods based on chemical extraction, the placement of surface coatings, laser decontamination methods, physical and mechanical methods, thermal methods, suction methods and washing methods.

Among these methods, chemical extraction methods use erosion of surface layers on surfaces to be decontaminated to evacuate the contamination from this surface. This can be done by acid erosion, dissolution in an acid or hydrogen peroxide medium, treatment of mixes of alkaline salts, caustic treatments with detergents, complexing by organic complexing agents, oxidation, oxidation-reduction and electro-polishing.

The purpose with all of these methods is to erode surface layers from the surface to be decontaminated, for example oxide layers for metals, which are the source of contamination.

Washing methods may include hot water, steam, super-heated steam or very high pressure water to dissolve the contaminating chemical species and also to erode surface layers from the surface to be decontaminated and thus eliminate the contamination. The decontamination methods mentioned above are described in the document “Decommissioning Technology Descriptions: Decontamination”, DOE, August 1st, 2000 [1].

Most of the above methods are aggressive towards the surface to be treated and their objective is to remove the passive layer or the oxide layer in which the contamination is located. Therefore, they are not suitable for maintenance decontamination and are not suitable when the surface properties of the material to be decontaminated must be kept.

Thus, in the nuclear fuel cycle industry, there is the problem of decontamination of oxidised and contaminated steels in which there may be very thick surface oxide layers when high temperature methods are used. This decontamination is done at the present time by washing with pressure demineralised water and sanding, but these methods are not fully satisfactory to the extent that the level of residual contamination is too close to the maximum allowable limits. Furthermore, these methods cause surface abrasion.

Therefore it would be useful to be able to use surface decontamination methods, particularly for metallic surfaces, in order to:

keep surface properties unchanged,

use existing decontamination equipment,

keep the cost low,

extend the life of equipment used in nuclear zones,

limit doses accumulated by work personnel,

produce easy-to-manage effluents, and

have a small impact on the environment.

Presentation of the Invention

This invention applies particularly to a method for decontaminating a contaminated surface, to achieve the objectives mentioned above using the complexing properties of this surface.

According to the invention, the method for decontaminating a surface, and particularly a metallic surface contaminated by contaminants Z₁, is characterised by the fact that the surface is brought into contact with an aqueous solution containing chemical species Z₂ that can displace contaminants Z₁ by an exchange mechanism at fixation sites on the surface of contaminants Z₁ such that the contaminants Z₁ are replaced by chemical species Z₂ on these fixation sites, and the aqueous solution containing the contaminants Z₁ thus displaced is separated from the decontaminated surface.

This method uses a mechanism for displacement of chemical desorption equilibriums of contaminants Z₁ in the required direction, in other words to release the said contaminants into the aqueous solution. This is facilitated by the fact that the physicochemical properties of the surface to be decontaminated can be used, particularly its complexing behaviour towards contaminants Z₁ and chemical species Z₂.

None of the methods according to prior art uses these properties for displacing contaminants in an aqueous solution, without also using abrasion or degradation of the surface to be decontaminated.

In general, fixation sites of contaminants Z₁ on the contaminated surface are composed of functional groups F present on this surface. In this case, chemical species Z₂ are used capable of reacting with these functional groups F, the chemical species Z₂ being such that the equilibrium constant K₂ for the reaction of these species with the groups F is greater than the equilibrium constant K₁ for the reaction of contaminants Z₁ with groups F.

According to one variant of the invention, the physicochemical properties of a surface can be used to prevent contamination of this surface.

Another purpose of the invention is a surface treatment method to prevent fixation of contaminants Z₁ on this surface, characterised in that the surface is brought into contact with an aqueous solution containing chemical species Z₂ capable of occupying fixation sites of contaminants Z₁ on this surface and that cannot subsequently be displaced from these sites by contaminants Z₁.

When the fixation sites of contaminants Z₁ are composed of functional groups F present on this surface, chemical species Z₂ capable of reacting with these functional groups F are used, the chemical species Z₂ being such that the equilibrium constant K₂ of the reaction of these species with the groups F is greater than the equilibrium constant K₁ of the reaction of contaminants Z₁ with groups F.

Therefore, in order to use methods according to the invention, elements about complexing properties of the surface to be treated with regard to contaminants Z₁ should be available, and the species Z₂ that could displace contaminants Z₁ from the surface to be decontaminated should then be selected.

When contaminants Z₁ are fixed on sites composed of functional groups F, the first step is to choose the chemical species Z₂ capable of chemically reacting with the functional groups F, and the equilibrium constant K₁ of the reaction of contaminants Z₁ with groups F, and equilibrium constants K₂ of chemical species Z₂ with groups F, are determined in order to select the chemical species Z₂ for which K₂ is greater than K₁.

After choosing the chemical species Z₂ able to ensure the decontamination, an aqueous solution containing these species at a concentration sufficient to cause saturation of this solution in species Z₂, is prepared.

Then, the solution is applied to the surface to be treated by any known means such as dipping, spraying with or without pressure, and circulation on the surface to be treated.

Then, the aqueous solution that entrained the contaminants Z₁ desorbed from the decontaminated surface is separated.

Preferably, the decontaminated surface is further rinsed with water, and then dried. Rinsing may be done using pure water and drying may for example be done with compressed air.

The method according to the invention may be used to decontaminate any material with complexing and/or adsorption properties, for example metals, metallic alloys, plastics, polymers and even some types of glass.

It is applicable to desorption of any contaminant fixed on the material by chemical or physicochemical reaction. Examples of contaminants that could be displaced by this method include metallic ions, and particularly the C^{s+}, Co²⁺, Ag⁺, Pb²⁺, Cd²⁺, etc, ions.

When contaminants Z₁ are ions, chemical species Z₂ also formed of ions can be used in order to displace contaminants by an ion exchange mechanism.

For example, the method according to the invention can be used to treat a metallic surface made of stainless steel contaminated by caesium or cobalt.

In this case, the caesium fixation sites are functional groups F composed of CrO groups, and the chemical species Z₂ used can be sodium ions since the equilibrium constants K₁ and K₂ of the following reactions:

Cr—O—H+Cs⁺⇄Cr—O—Cs+H⁺(K₁)

Cr—O—H+Na⁺⇄Cr—O—Na+H⁺(K₂)

by which the Cr—O—Cs and Cr—O—Na compounds are formed are such that K₂ is greater than K₁.

Consequently, an exchange of caesium ions and sodium ions is obtained according to the following reaction scheme:

Cr—O—Cs+Na⁺ [symbol] Cr—O—Na+Cs⁺

This reaction shows that by incorporating an Na⁺ ion into the aqueous decontaminating phase, the efficiency with which a surface is decontaminated by water can be improved.

In general, the aqueous solution used for this decontamination is an aqueous solution of sodium and/or potassium ions with a total concentration of Na⁺ and/or K⁺ ions varying from 10⁻⁸ to about 3 g/l.

When the method according to the invention is used for treatment of a surface to prevent fixation of contaminants Z₁ on this surface, the chemical species Z₂ that could be used are chosen in the same way, the aqueous solution containing these chemical species Z₂ is then prepared, and this solution is brought into contact with the surface to be treated to saturate possible fixation sites of contaminants Z₁ with chemical species Z₂.

In the case of a stainless steel surface that could be contaminated by caesium or cobalt, an aqueous solution of sodium and/or potassium with a sodium and/or potassium concentration of 10⁻⁸ to 3 g/l could also be used to prevent fixation of the caesium or cobalt.

The method according to the invention has many advantages. It is easy to use and efficient. It uses aqueous solutions that are not aggressive towards the treated surfaces and is selective with regard to contaminants to be eliminated. Furthermore, it provides a means of keeping the surface properties of the treated material; and it leads to effluents that are easy to manage since they can be evaporated and introduced for example into the vitrification circuit of spent nuclear fuel reprocessing installations. It can also be used in existing decontamination installations.

Other characteristics and advantages of the invention will become clearer after reading the following description, which is given obviously as an illustrative and non-limitative example, with reference to the attached drawing.

### BRIEF DESCRIPTION OF THE DRAWING

FIG. 1 is a graph illustrating the variation of the decontamination factor for a metallic surface contaminated by caesium ions as a function of the sodium content of the aqueous solution used for this decontamination.

### DETAILED PRESENTATION OF AN EMBODIMENT

The following describes use of the method according to the invention to decontaminate a metallic stainless steel surface contaminated by caesium, using Na⁺ ions to displace the Cs⁺ ions from the surface using the ion exchange mechanism described above.

This operation is done using an aqueous solution of NaOH and the influence of the concentration of sodium on the decontamination factor FD is studied.

Several stainless steel samples contaminated by caesium are used and are dipped for 24 hours in aqueous solutions of NaOH with concentrations of sodium increasing from 5×10⁻⁹ mol.L⁻¹ to 2×10⁻⁵ mol/L⁻¹.

In each case, the caesium concentration of the aqueous solution after dipping is determined to calculate the decontamination factor FD that corresponds to the ratio between the contaminant quantities removed by the solution to be tested and quantities removed by pure water.

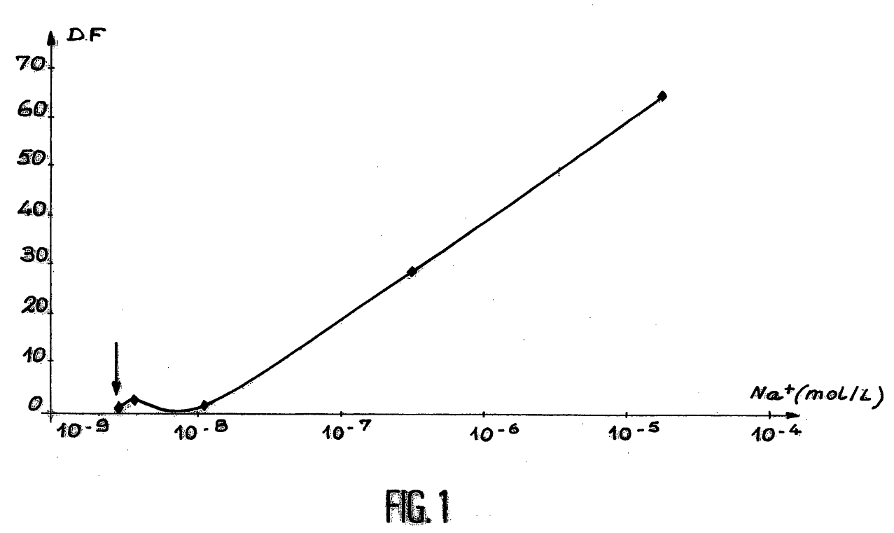

The results obtained are shown in FIG. 1 attached that illustrates the variation of FD as a function of the sodium concentration (in mol.L⁻¹).

In this figure, the starting point of the curve is applicable to demineralised water. Thus, it can be seen that by adding a small quantity of sodium ions into demineralised water, the decontamination efficiency of caesium on the stainless steel surface is multiplied by a factor of more than 60.

Thus, the method according to the invention enables removal of volatile caesium type contamination. No changes to the surface properties of the material are observed.

When this method is used in the nuclear fuel cycle industry, the total residual surface contamination at the end of the treatment can be reduced to very much below allowable standards and therefore:

only a single decontamination operation is necessary, and

plant operating costs are reduced.

### Reference Mentioned

[1] “Decommissioning Technology Descriptions: Decontamination” DOE, August 1st, 2000.

1. Method of decontamination of a surface contaminated by contaminants Z₁, characterised in that the surface is brought into contact with an aqueous solution containing chemical species Z₂ that can displace contaminants Z₁ by an exchange mechanism at fixation sites on the surface of contaminants Z₁ such that the contaminants Z₁ are replaced by chemical species Z₂ on these fixation sites, and the aqueous solution containing the contaminants Z₁ thus displaced is separated from the decontaminated surface.

2. Method according to claim 1, in which fixation sites of contaminants Z₁ on the contaminated surface are composed of functional groups F present on this surface and chemical species Z₂ capable of reacting with these functional groups F are used, the chemical species Z₂ being such that the equilibrium constant K₂ for the reaction of these species with the groups F is greater than the equilibrium constant K₁ for the reaction of contaminants Z₁ with groups F.

3. Method according to either of claims 1 and 2, in which the decontaminated surface is rinsed with water and dried.

4. Method according to any one of claims 1 to 3, in which contaminants Z₁ and chemical species Z₂ are ions.

5. Method according to any one of claims 1 to 4, in which the surface is a metallic surface.

6. Method according to claim 5, in which the metallic surface is made of stainless steel.

7. Method according to claim 6, in which functional groups F are CrO groups, contaminants Z₁ are caesium or cobalt ions and chemical species Z₂ are sodium and/or potassium ions.

8. Method according to claim 7, in which the aqueous solution is a solution of Na+ and/or K+ions with a total concentration of sodium and/or potassium of 10⁻⁸ to 3 g/l.

9. Method for the treatment of a surface so as to prevent fixation of contaminants Z₁ on this surface, characterised in that the surface is brought into contact with an aqueous solution containing chemical: species Z₂ capable of occupying fixation sites of contaminants Z₁ on this surface and that cannot subsequently be displaced from these sites by contaminants Z₁.

10. Method according to claim 9, in which fixation sites of contaminants Z₁ are composed of functional groups F present on this surface, chemical species Z₂ are used, capable of reacting with these functional groups F, the chemical species Z₂ being such that the equilibrium constant K₂ of the reaction of these species with the groups F is greater than the equilibrium constant K₁ of the reaction of contaminants Z₁ with groups F.

11. Method according to either of claims 9 and 10, in which the contaminants Z₁ and the chemical species Z₂ are ions.

12. Method according to any one of claims 9 to 11, in which the surface is a metallic surface.

13. Method according to claim 12, in which the metallic surface is made of stainless steel.

14. Method according to claim 13, in which the functional groups F are CrO groups, contaminants Z₁ are caesium or cobalt ions and chemical species Z₂ are sodium and/or potassium ions.

15. Method according to claim 14, in which the aqueous solution is a solution of Na+ and/or K+ ions with a total concentration of sodium and/or potassium of 10⁻⁸ to 3 g/l.
